(19) United States
(12) Patent Application Publication
(10) Pub. No.: US 2018/0137202 A1
(43) Pub. Date: May 17, 2018

(54) SOCIAL BASED ONLINE MATCHMAKING SYSTEM

(71) Applicant: Dev Melepura, Floral Park, NY (US)

(72) Inventor: Dev Melepura, Floral Park, NY (US)

(21) Appl. No.: 15/375,605

(22) Filed: Dec. 12, 2016

Related U.S. Application Data
(60) Provisional application No. 62/286,819, filed on Jan. 25, 2016.

(51) Int. Cl. G06F 17/30; H04L 29/08; H04L 12/58

(52) U.S. Cl. CPC G06F 17/30867; H04L 51/32; H04L 67/10; H04L 67/306

(57) ABSTRACT

Systems and methods for social based online matchmaking system are provided. In particular, some embodiments provide recommendations for connections (i.e., candidate users) based on the user's social networking and social matching system connections and activity. Along with one-on-one dates, the user can enable communications within to establish group outings with a candidate user, and each of their respective friend groups which may include single or non-single friends. For example, the user can create a dialog with a candidate user from their extended degrees of social connections and a separate dialogue with friends (i.e., non-candidate users). The user may not be able to see full dating profiles of the non-candidate users, which may be the user's friends or the candidate user's shortlisted friends. Additionally, a user can disable the matchmaking features and show that they have done so to the rest of the users to indicate a status of not looking.

### FIELD OF THE INVENTION

This disclosure relates to online matchmaking systems.

### BACKGROUND OF THE INVENTION

In recent years, access to the internet has become increasingly widespread. As such, there has been a steady increase to the amount of daily activities that individuals conduct via the internet. Among these, matchmaking services have become increasingly prevalent.

Most matchmaking services allow users to input their own personal profile information and then browse the service for suitable matches. Many online services also provide algorithms to help users locate suitable matches based on similar profile information or interests.

The matchmaking services described above have failed to provide matching services through an individual's own personal social network that have somewhat been happening traditionally in the real the world. One example is that an individual speaks to a potential match that was brought to a social gathering by a friend of that individual. Another example is meeting a potential match at a social gathering along with friends, and/or meeting a potential match at a social gathering along with the potential match's friends. Seeking potential matches through one's own social networks can provide a level of security and trust that users cannot attain from meeting total strangers through online matchmaking services. It would be advantageous to combine the unique benefits of personal social networks with the convenience and breadth provided by online matchmaking services.

Therefore, there is a need for an improved online matchmaking system.

### SUMMARY OF THE INVENTION

The present invention relates to a social based online matchmaking system that lets a user view, click interested, click not interested, and if there is a mutual interest message profiles of matches from the user's second to third degree of connection or open connection on the system.

In one embodiment of the present invention for the social based matchmaking system, comprising:
a) Said user registers and allows the system to access the user's online social network;
b) Said user has the option to invite others to join the system;
c) If any of the first degree of connection from the said user's social network joins or are already part of the system, those connections would become part of the user's first degree of connection on the system;
d) Said user can input additional profile data into the system;
e) Said user only has potential matches from a second to third degree of connection or open connection on the system;
f) Matches from a second to third degree of connection comes from when there is a linked connection(s) in the system that is between the user and the second to third degree of connection;
g) Open connection matches are matches from outside the second and third degree of connection;
h) Said user has the ability to view the matching profiles of potential matches from the user's second to third degree of connection or open connection on the system that matches the said user's preference criteria or of a match that liked the said user's profile;
i) Said user has the ability to view just the extremely limited details from the profiles of the user's first degree of connection and the third degree and open connection matches' short listed first degree of connection as described in
j) Said user can freely message their first degree connections, and reply to any active messages in their message box;
k) Said user can only initiate a message with matches on their second to third degree of connection if there is a mutual interest and that the user has full access through an initial free trial, an incentivized membership, a promotional membership, or a paid membership;
l) Once said user loses full access they could only view the partial profiles for other users in the second to third degree or open connection who also don't have full access, but can view the full profiles of other users who has full access;
m) Said user can shortlist the connections from their first degree of connection, and their shortlisted first degree of connection would be viewable on their profile to their potential matches from their third degree or open connection;
n) Said user will have a certain type of messages in their inbox where it would be for messages with someone from their first degree of connection and for messages with the shortlisted first degree of connection from their matches, where links with the message to each other's profiles only shows the extremely limited profiles described in “i”;
o) Said user will have another type of messages in their inbox where it would be for messages with someone from their second to third degree of connection or open connection, where links with the messages to each other's profiles only shows partially limited or full profiles depending on the said user's access and the access of who is being messaged as described in “l”;
p) Said user can change their access to where their extremely limited profile is just for viewing and for messaging as described in “i” and “n”, and an indication of their different access is viewable to the users that can view them in the system, and where their partial or full profiles won't be available for viewing or for messaging as described in “l” and “o”;
q) Said system can alternatively be a free or advertisement based system for the said user where the said user will have full access, and won't be attaining full access through the reasons described in “k” or lose full access as describe in “l”;
r) Said system can alternatively or can also alternatively include extended degrees of connections where those connections would function in the same way as a third degree of connection for the said user; and
s) Said system can alternatively or can also alternatively include open connection matches as matches from outside the second degree of connection and not include third degree connections.

### DETAILED DESCRIPTION OF THE INVENTION

The social based online matchmaking system of the present invention will herein be described. This Social Based Online Matchmaking System flow starts when a user who is seeking a match registers to the system with their online social networking account. This allows the system to access the user's online social network. User can then invite others to join this system. If any of the first degree of connection from the user's social network joins or are already members of the system, those connections would become part of the user's first degree of connection on the system.

The user can input additional profile data into the system. Some of data needed for the profile are auto-populated from the user's social network.

The user will only has a second to third degree of connection or open connection on the system.

Matches from a second to third degree of connection comes from when there is a linked connection(s) in the system that is between the user and the second to third degree of connection.

Open connection matches are matches from outside the second and third degree of connection.

The user has the ability to view the matching profiles of potential matches from the user's second to third degree of connection or open connection on the system that matches the said user's preference criteria or of a match that liked the said user's profile.

The user has the ability to view just the extremely limited details from the profiles of the user's first degree of connection and the third degree and open connection matches' short listed first degree of connection as described in [0018].

The user can freely message their first degree connections, and reply to any active messages in their message box.

The user can only initiate a message with matches on their second to third degree of connection if there is a mutual interest and that the user has full access through an initial free trial, an incentivized membership, a promotional membership, or a paid membership.

Once the user loses full access they could only view the partial profiles for other users in the second to third degree or open connection who also don't have full access, but can view the full profiles of other users who has full access.

The user can shortlist the connections from their first degree of connection, and their shortlisted first degree of connection would be viewable on their profile to their potential matches from their third degree or open connection.

The user will have a certain type of messages in their inbox where it would be for messages with someone from their first degree of connection and for messages with the shortlisted first degree of connection from their matches, where links with the message to each other's profiles only shows the extremely limited profiles described in [0014].

The user will have another type of messages in their inbox where it would be for messages with someone from their second to third degree of connection or open connection, where links with the messages to each other's profiles only shows partially limited or full profiles depending on the said user's access and the access of who is being messaged as described in [0017].

The user can change their access to where their extremely limited profile is just for viewing and for messaging as described in [0014] and [0019], and an indication of their different access is viewable to the users that can view them in the system, and where their partial or full profiles won't be available for viewing or for messaging as described in [0017] and [0020].

The system can alternatively be a free or advertisement based system for the said user where the said user will have full access, and won't be attaining full access through the reasons described in [0016] or lose full access as describe in [0017].

The system can alternatively or can also alternatively include extended degrees of connections where those connections would function in the same way as a third degree of connection for the said user.

The system can alternatively or can also alternatively include open connection matches as matches from outside the second degree of connection and not include third degree connections.

### EXAMPLES

The following Examples demonstrate the present invention and its capability for use. The invention is capable of other and different embodiments, and its several details are capable of modifications in various apparent respects, without departing from the scope and spirit of the present invention. Accordingly, the Examples are to be regarded as illustrative in nature and non-limiting.

### Example 1

TABLE 1

| | |
|---|---|
| User: | Tom |
| Tom's Friend: | Annie |
| Annie's Friend: | Tara |
| Third Degree Match: | Jane |

Table 1 describes individual roles being used for Example 1. Tom heard about a new online dating portal, and visited the website. He saw a presentation on how the portal would work on the homepage of the site, he understood that it is an online dating portal that lets him connect with potential matches from his second degree and third degree of connection, and he decided to give it a shot. He registers for the portal and links his account with his online social networking account. He creates a dating profile on the portal. While putting in the details for his dating profile, he noticed some of things were auto-populated; like his profile picture, age, etc. He then invites some of his friends from his online social network to become part of his first degree of connection on the portal, and some joins. Some of his other friends on his online social network heard about it in other ways, and they also joined, so they became part of his first degree of connection on the portal too.

On the portal Tom could only access a mini profile for people in his first degree of connection, and that mini profile just included a profile picture, a name, and a message button. But he could see the full dating profiles of potential matches in his second degree and third degree of connection. Then he noticed someone in his second degree that he was thought he would match well with, Tara.

On Tara's profile he saw that the mutual friend that connected him to Tara was his distant friend Annie. Through the portal he noticed that he had two options; message Annie to make an introduction, or click the like button on Tara's profile. A day later he got a notification that there was mutual interest with Tara, she also liked Tom's profile. Tom messaged Tara and he got a reply. Tom & Tara both separately messaged Annie regarding the other, and heard positive things about the other, and they decided to meet.

Another time Tom saw a match from his third degree that he was he would really match well with, Jane.

On Jane's profile, Tom noticed that her list of her close friends are viewable on her profile, and Tom could only access a mini profile for her close friends, and that mini profile just included a profile picture, a name, and a message button. Through the portal he noticed that he had two options; message one of her close friends to inquire about her, or click the like button on Jane's profile. He clicked the like button. Then a day later he got a notification that there was a mutual interest with Jane, she also liked Tom's profile. Tom messaged one of Jane's close friends to inquire about Jane. Jane independently messaged one of Tom's close friends from his profile to inquire about Tom. They heard positive things about the other, started to message each other, and then decided to meet.

Later Tom got into a serious relationship with Jane, and decided that he should deactivate the account on the portal. While trying to delete his account he noticed that he had three options; one to remain on the portal as a connector, second to deactivate the account, and third to delete the account. He noticed that with the connector option he could remain on the portal and by remaining on the portal he would be providing a link for his friends to connect to potential second and third degree matches through his account/connection. With the connector option he also noticed that just his mini profile with his profile picture, name, and message button will be viewable on the portal to his friends; and if he was selected/shortlisted as a close friend by one of his friends, his mini profile would be viewable and available to message for that friend's third degree potential matches. And he also noticed that an indication that he has the connector access is viewable to the users that can view him on the portal. So he decided to remain on portal, because he found Jane through it, and thought to pay it forward.

While the illustrative embodiments of the invention have been described with particularity, it will be understood that the invention is capable of other and different embodiments and that various other modifications will be apparent to and may be readily made by those skilled in the art without departing from the spirit and scope of the invention. Accordingly, it is not intended that the scope of the claims hereof be limited to the examples and descriptions set forth herein but rather that the claims be construed as encompassing all the features of patentable novelty which reside in the present disclosure, including all features which would be treated as equivalents thereof by those skilled in the art to which the invention pertains.

### BRIEF DESCRIPTION OF DRAWINGS

Embodiments of the present invention will be described and explained through the use of the accompanying drawings in which:

FIG. 1 illustrates an example of a networked-based environment in which some embodiments of the present invention may be utilized;

FIG. 2 is a diagram illustrating how connections between users of a social network can be utilized to identify candidate users in accordance with various embodiments of the present invention; and

FIG. 3, FIG. 4 and FIG. 5 are graphical user interface screens which may be used in various embodiments of the present invention.

### DETAILED DESCRIPTION OF THE PREFERRED EMBODIMENTS

The herein described drawing figures illustrate the invention in at least one preferred, best mode embodiment, which is further defined in detail in the following description. Those having ordinary skill in the art may be able to make alterations and modifications to what is described herein without departing from its spirit and scope. Therefore, it should be understood that what is illustrated is set forth only for the purposes of example and should not be taken as a limitation on the scope of the present apparatus and its method of use.

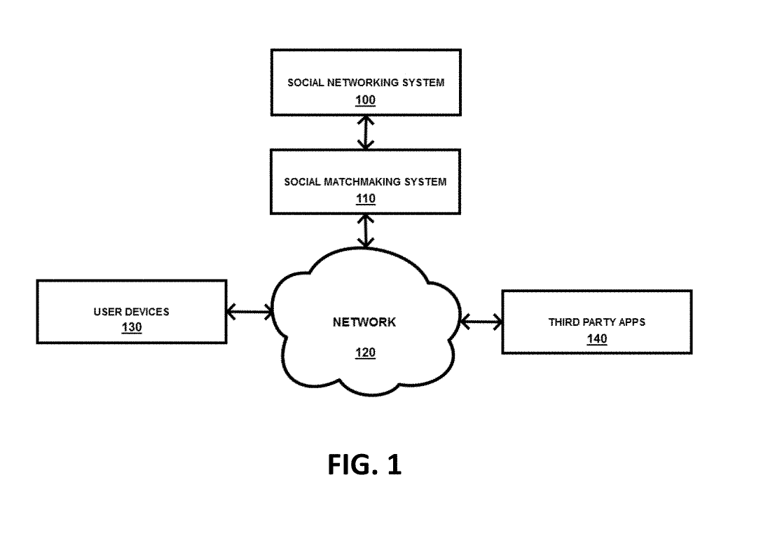

FIG. 1 illustrates an example of a networked-based environment in which some embodiments of the present invention may be utilized. As illustrated in FIG. 1, various applications 140, and/or user devices 130 other devices can be used to access social matchmaking system 110 which works along with social networking system 100. These devices and tools may use network 120 to submit and retrieve information from social matchmaking system 110. User device 130 can be any computing device capable of receiving user input as well as transmitting and/or receiving data via the network 120. User devices 130 can be configured to communicate via the network 120, which may comprise any combination of local area and/or wide area networks, using both wired and wireless communication systems. In one embodiment, user device 130 can be a conventional computer system, such as a desktop computer, laptop computer, or a mobile device having computer functionality, such as a smart-phone or similar device. In one embodiment, user device 130 executes an application allowing a user of user device 130 to interact with the social matchmaking system 110. For example, user device 130 can execute a browser application to enable interaction between the user device 130 and social matchmaking system 110 via the network 120. In another embodiment, user device 130 interacts with social matchmaking system 110 through an application programming interface (API) that runs on the native operating system of the user device 130.

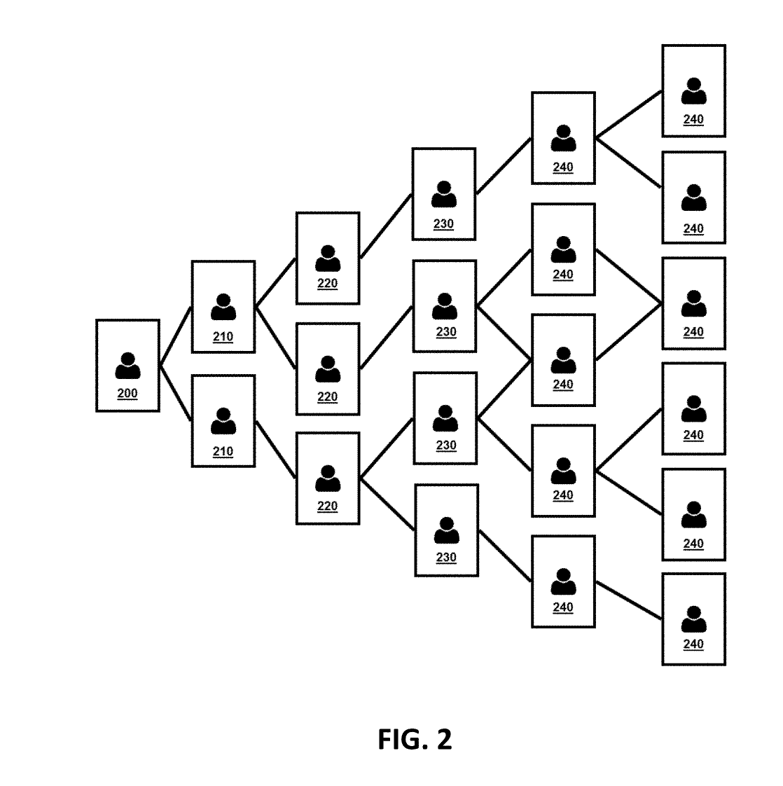

FIG. 2 is a diagram illustrating how connections between users of social networking system 100 and social matchmaking system 110 can be utilized to identify candidate users in accordance with various embodiments of the present invention. User 200, using user device 130, for example, can submit a request to identify a set of candidate users. The candidate users on social matchmaking system 110 should be members of the social networking system 100 too. The social matchmaking system 110 also displays certain non-candidate users to the users too, like any of the first degree of connection 210 from the said user's social network 100 joins or are already part of the system 110, those connections would become part of the user's first degree of connection 210 on the system 110. The user 200 only has potential matches from a second 220 to third degree 230 of connection or open connection 240 on the system 110. The candidate users come from a second 220 to third 230 degree of connection comes from when there is a linked connection(s) in the system 110 that is between the user 200 and the second 220 to third 230 degree of connection. The open connection candidate users 240 are users from outside the second 220 and third 230 degree of connection. The user 200 has the ability to view the candidate user profiles of potential matches from the user's second 220 to third 230 degree of connection or open 240 connection on the system that matches the said user's preference criteria or of a match that liked the said user's profile.

A preference set or set of criteria may be used to rank the candidate users and/or select only a subset of the candidate users. The preference set can also include other filters such as, but not limited to, interested in men, interested in women, geographic limitations, age ranges, and the like. In some embodiments, the candidate users may be further restricted based on participation preferences and/or privacy policies set within social matchmaking system 110. The candidate users may be presented through a graphical user interface screens (e.g., as illustrated in FIG. 4).

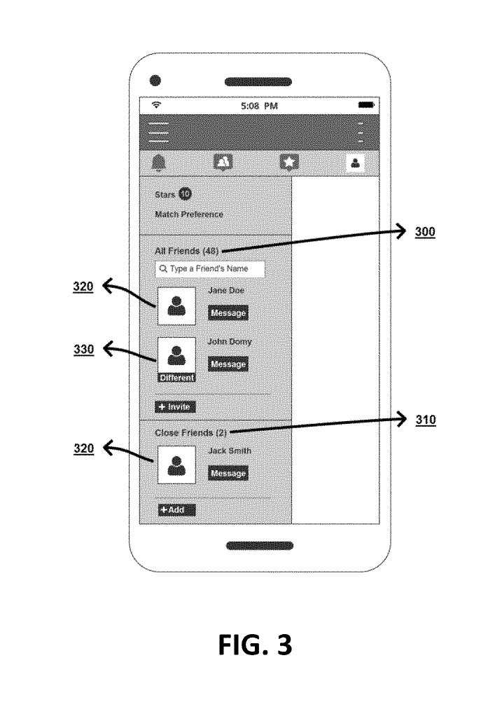

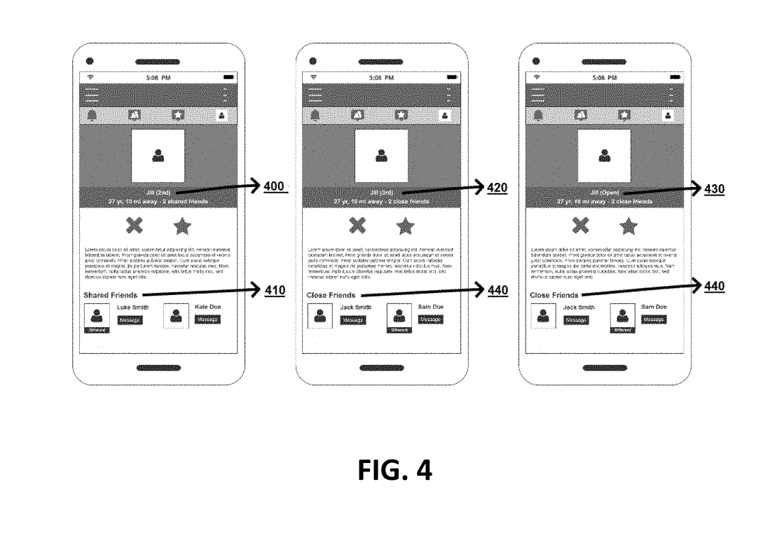

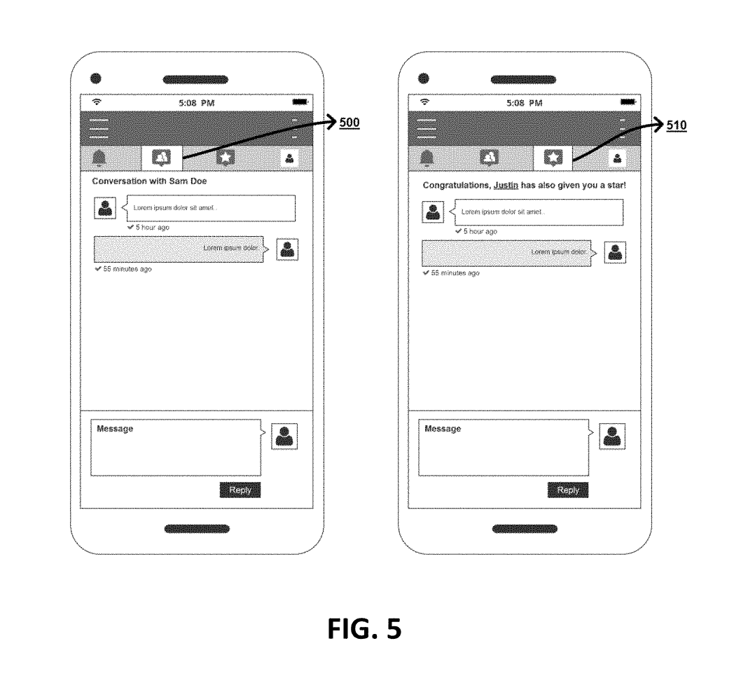

FIG. 3, FIG. 4 and FIG. 5 illustrates graphical user interface screens which may be used in various embodiments of the present invention. GUI illustrates how information might be presented to the user regarding the candidate or to the candidate regarding the user. GUI also illustrates how information might be presented to the user regarding the non-candidate or to the non-candidate regarding the user. The information may include the profile picture and name, in addition to anything else set as public information (e.g., location, age, interests, etc.). FIG. 3 illustrates graphical user interface screen which depicts how a non-candidate would be displayed to the user. FIG. 4 illustrates graphical user interface screens which depict how a user would be displayed to a candidate.

The user 200 has the ability to view just the extremely limited details from the profiles of the user's first 210 degree of connection and the third 440 degree and open 440 connection matches' short listed first degree of connection 310 as depicted in 310 and 440. The system 110 can alternatively or can also alternatively include extended degrees of connections 220, 230 or 240 where those connections would function in the same way as a third 230 degree of connection for the user 200. The said system 110 can alternatively or can also alternatively include open connection 240 matches as matches from outside the second degree 220 of connection and not include third 230 degree connections.

FIG. 3 illustrates graphical user interface screen which depicts how a non-candidate may be displayed to the user. User 200 can shortlist the connections 310 from their first degree of connection 300, and their shortlisted first degree of connection 310 would be viewable on their profile to their matches from their third 230 degree or open connection 240. User 200 can change their access to where their extremely limited profile is just for viewing and for messaging, and an indication of their different access 330 is viewable to the users 320 that can view them in the system 110, and where their partial or full profiles won't be available for viewing or for messaging with matches.

FIG. 5 illustrates graphical user interface screens which depict how a user would be displayed to a candidate. On the system 110 user 200 can freely message their first 210 degree connections, and reply to any active messages in their message box 500. User 200 will have a certain type of messages in their inbox 500 where it would be for messages with someone from their first degree of connection 210 and for messages with the shortlisted first degree of connection 310 from their matches, where links with the message to each other's profiles only shows the extremely limited profiles. User 200 will have another type of messages in their inbox 510 where it would be for messages with someone from their second 220 to third 230 degree of connection or open 240 connection, where links with the messages to each other's profiles only shows partially limited or full profiles depending on the said user's access and the access of who is being messaged. User 200 can only initiate a message with candidates on their second 220 to third 230 degree or open 240 connection if there is a mutual interest and that the user has full access through an initial free trial, an incentivized membership, a promotional membership, or a paid membership.

What is claimed is:

1. A method comprising: a social based online matchmaking system for matching users.

2. The method of claim 1, wherein said user registers and allows the system to access the user's online social network.

3. The method of claim 1, wherein said user has the option to invite others to join the system.

4. The method of claim 1, wherein if any of the first degree of connection from the said user's social network joins or are already part of the system, those connections would become part of the user's first degree of connection on the system.

5. The method of claim 1, wherein said user can input additional profile data into the system.

6. The method of claim 1, wherein said user only has potential matches from a second to third degree of connection or open connection on the system.

7. The method of claim 1, wherein matches from a second to third degree of connection comes from when there is a linked connection(s) in the system that is between the user and the second to third degree of connection.

8. The method of claim 1, wherein open connection matches are matches from outside the second and third degree of connection.

9. The method of claim 1, wherein said user has the ability to view the matching profiles of potential matches from the user's second to third degree of connection or open connection on the system that matches the said user's preference criteria or of a match that liked the said user's profile.

10. The method of claim 1, wherein said user has the ability to view just the extremely limited details from the profiles of the user's first degree of connection and the third degree and open connection matches' short listed first degree of connection as described in claim 14.

11. The method of claim 1, wherein said user can freely message their first degree connections, and reply to any active messages in their message box.

12. The method of claim 1, wherein said user can only initiate a message with matches on their second to third degree or open connection if there is a mutual interest and that the user has full access through an initial free trial, an incentivized membership, a promotional membership, or a paid membership.

13. The method of claim 1, wherein once said user loses full access they could only view the partial profiles for other users in the second to third degree or open connection who also don't have full access, but can view the full profiles of other users who has full access.

14. The method of claim 1, wherein said user can shortlist the connections from their first degree of connection, and their shortlisted first degree of connection would be viewable on their profile to their potential matches from their third degree or open connection.

15. The method of claim 1, wherein said user will have a certain type of messages in their inbox where it would be for messages with someone from their first degree of connection and for messages with the shortlisted first degree of connection from their matches, where links with the message to each other's profiles only shows the extremely limited profiles described in claim 10.

16. The method of claim 1, wherein said user will have another type of messages in their inbox where it would be for messages with someone from their second to third degree of connection or open connection, where links with the messages to each other's profiles only shows partially limited or full profiles depending on the said user's access and the access of who is being messaged as described in claim 13.

17. The method of claim 1, wherein said user can change their access to where their extremely limited profile is just for viewing and for messaging as described in claim 10 and claim 15, and an indication of their different access is viewable to the users that can view them in the system, and where their partial or full profiles won't be available for viewing or for messaging as described in claim 13 and claim 16.

18. The method of claim 1, wherein said system can alternatively be a free or advertisement based system for the said user where the said user will have full access, and won't be attaining full access through the reasons described in claim 12 or lose full access as describe in claim 13.

19. The method of claim 1, wherein said system can alternatively or can also alternatively include extended degrees of connections where those connections would function in the same way as a third degree of connection for the said user.

20. The method of claim 1, wherein said system can alternatively or can also alternatively include open connection matches as matches from outside the second degree of connection and not include third degree connections.
